(19) United States
(12) Patent Application Publication
(10) Pub. No.: US 2020/0390059 A1
(43) Pub. Date: Dec. 17, 2020

(54) Folding Pet Cage

(71) Applicant: Langfang Juwangshang E-Commerce Co., Ltd., Hebei (CN)

(72) Inventor: Xiaochen Liu, Hebei (CN)

(21) Appl. No.: 16/507,257

(22) Filed: Jul. 10, 2019

(30) Foreign Application Priority Data
Jun. 17, 2019 (CN) 201920909745.8

(51) Int. Cl. A01K 1/03; A01K 1/015

(52) U.S. Cl. CPC A01K 1/03; A01K 1/0151

(57) ABSTRACT

A folding pet cage includes two first frames arranged opposite to each other, two second frames arranged opposite to each other and a bottom net, wherein the first frame is in rotatable connection with the adjacent second frame, the first frame and the second frame enclose an activity space; the second frame includes at least two frame bodies, and any two adjacent frame bodies are in rotatable connection; the first frame and/or the frame body have/has one side near the activity space provided with a protrusion piece, the bottom net can be placed above the protrusion piece and the bottom net has a peripheral side contacting the first frame and the second frame, and feces excreted by a pet located above the bottom net can pass through the bottom net to fall below the bottom net.

### CROSS REFERENCE TO RELATED APPLICATION

This application claims priority to and takes the benefit of Chinese Patent Application No. 201920909745.8 filed on Jun. 17, 2019 the contents of which are herein incorporated by reference.

### TECHNICAL FIELD

The disclosure relates to the technical field of pet cages, and in particular to a folding pet cage.

### BACKGROUND

With the progress and development of the society, the raising of pet dogs becomes more widespread. In common conditions, in pet shops pet dogs are placed in pet cages for easy care and feeding. Meanwhile, in daily lives, people also buy appropriate pet cages to raise pet dogs.

For convenient transportation, pet cages in existing technologies generally are detached into multiple frames and are provided with bolts and nuts used for connecting the multiple frames. After a user buys a pet cage, he/she connects the multiple frames of the pet cage using the bolts and nuts manually at home. During the process of mounting the pet cage, since many parts need to be connected using the bolts, the user needs a long time to mount the pet cage independently. The mounting is quite inconvenient.

The applicant finds that existing technologies have the following technical problems.

The pet cages in existing technologies cost users a long time to mount. The mounting is inconvenient.

### SUMMARY

The disclosure aims to provide a folding pet cage, so as to solve the technical problems in existing technologies that pet cages cost users a long time to mount and are inconvenient to mount. Among many technical schemes provided by the disclosure, preferred technical schemes can produce many technical effects (simple structure, convenient usage, and low manufacturing cost) that will be illustrated hereinafter in detail.

In order to achieve the above aim, the disclosure adopts a technical means as follows.

The disclosure provides a folding pet cage, including two first frames arranged opposite to each other, two second frames arranged opposite to each other and a bottom net, wherein the first frame is in rotatable connection with the adjacent second frame, the first frame and the second frame enclose an activity space; the second frame includes at least two frame bodies, and any two adjacent frame bodies are in rotatable connection; the first frame and/or the frame body have/has one side near the activity space provided with a protrusion piece, the bottom net can be placed above the protrusion piece and the bottom net has a peripheral side contacting the first frame and the second frame, and feces excreted by a pet located above the bottom net can pass through the bottom net to fall below the bottom net.

Preferably, the first frame includes a fence region, the protrusion piece is located below the fence region, and the protrusion piece is connected with the fence region.

Preferably, at least two protrusion pieces are arranged below the fence region.

Preferably, the first frame is further provided with a support rod, and the support rod is located below the fence region; a bracket has two sides arranged opposite to each other provided with an extension portion respectively, and the extension portion can be put above the support rod on a corresponding side; the pet cage further includes a tray, and when the tray is placed on the bracket, the tray and the bottom net has a distance therebetween.

Preferably, the bracket has a length less than a length of the support rod, a region on the bracket provided with the extension portion is a suspension region, the suspension region is provided with at least two extension portions, and the suspension region has two end portion regions along its length direction both provided with the extension portion.

Preferably, a rotating wheel is arranged below the first frame.

Preferably, the pet cage further includes an upper frame, the upper frame has one end in rotatable connection with one of the two first frames, the upper frame is capable of rotating around where the upper frame is in rotatable connection with the first frame, and the upper frame has the other end in detachable connection with the other one of the two first frames.

Preferably, the first frame defines a pet exit, an openable and closable door is arranged at the pet exit, the openable and closable door has one end in rotatable connection with the first frame, and the openable and closable door has the other end in detachable connection with the first frame; the openable and closable door defines a feeding opening, a feeding door is arranged at the feeding opening, the feeding door has one end in rotatable connection with the openable and closable door, and the feeding door has the other end in detachable connection with the openable and closable door.

Preferably, the detachable connection includes a locking portion and a limit piece, the limit piece is arranged on the openable and closable door, the locking portion is arranged on the first frame, the locking portion has a slide block provided therein, the slide block is capable of performing reciprocating rectilinear movement in the locking structure along a vertical direction, the slide block defines a notch, a locking hook is arranged at the notch, when the limit piece is pushed in a direction towards the locking portion, the limit piece is capable of pushing the slide block to move upwards and the limit piece can enter a lockup region between the locking hook and the slide block, and the locking hook is capable of preventing the limit piece disengaging from the locking portion.

Preferably, the feeding opening is near a lower region of the openable and closable door.

When the folding pet cage provided in the disclosure is not used, the second frame is folded. When to mount and use the folding pet cage, it is only needed to pull the two first frames arranged opposite to each other away from each other to unfold the second frames, then the bottom net is placed on the protrusion piece in the activity space to prop up the first frame and the second frame. A pet can stand on the bottom net and move in the activity space enclosed by the first frame and the second frame. The folding pet cage is simple in structure, convenient to mount and suitable for widespread use.

### BRIEF DESCRIPTION OF THE DRAWINGS

For a better understanding of the technical scheme in the embodiments of the disclosure or in the prior art, accompanying drawings needed in the description of the embodiments or the prior art are simply illustrated below. Obviously, the accompanying drawings described below are some embodiments of the disclosure. For the ordinary skill in the field, other accompanying drawings may be obtained according to these accompanying drawings without creative work.

FIG. 1 is an overall structure diagram of a folding pet cage when opened according to the disclosure.

FIG. 2 is a structure diagram of a folding pet cage when folded according to the disclosure.

FIG. 3 is a top view of a folding pet cage when folded according to the disclosure.

FIG. 4 is an enlarged view of a portion on a folding pet cage according to the disclosure, where an upper frame is in detachable connection with a first frame.

FIG. 5 is an enlarged view of a portion on a folding pet cage according to the disclosure, where an openable and closable door is in detachable connection with a first frame.

FIG. 6 is a structure diagram of a bracket of a folding pet cage according to the disclosure.

FIG. 7 is a structure diagram of a bottom net of a folding pet cage according to the disclosure.

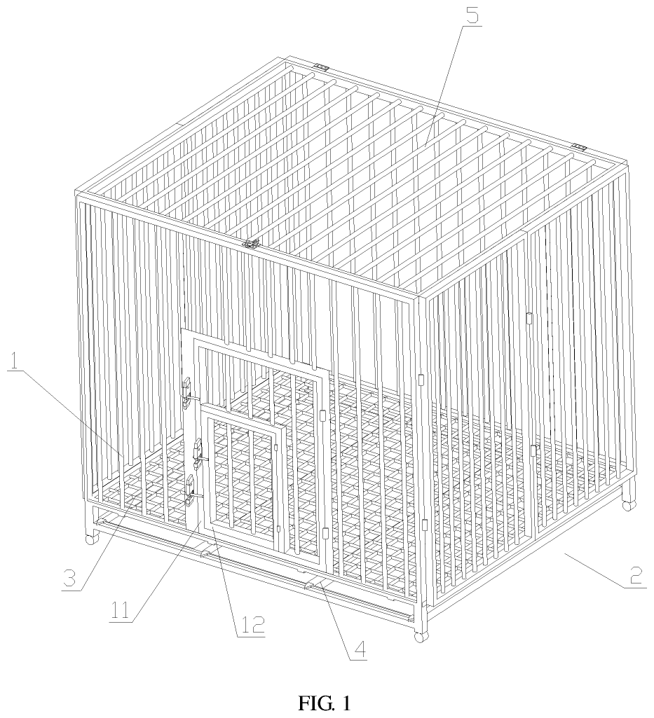

In FIG. 1, 1 represents a first frame, 11 represents an openable and closable door, 12 represents a feeding door, 13 represents a protrusion piece, 14 represents a rotating wheel, 15 represents a fence region, 16 represents a support rod, 2 represents a second frame, 21 represents a frame body, 3 represents a bottom net, 4 represents a bracket, 41 represents a suspension region, 42 represents an extension portion, 5 represents an upper frame, 6 represents a limit piece, 7 represents a locking portion, 71 represents a shell, 711 represents a bolt, 72 represents a slide block, 721 represents a locking hook, 722 represents a lockup space, 723 represents a translation space, 724 represents a side wall, 725 represents a bottom wall, 8 represents a rotating portion, 81 represents a bottom plate, 82 represents a rotating member, 821 represents a guide groove, 83 represents a locating piece, 84 represents an anti-off pin, 85 represents a screw, 9 represents a snap-fit portion, 91 represents an L-shaped member, and 92 represents a fixed plate.

### DESCRIPTION OF THE EMBODIMENTS

The purpose, the technical scheme and the advantages of the disclosure will become more clearly understood from detailed description of the technical scheme of the disclosure. Obviously, the embodiments described hereinafter are simply part embodiments of the disclosure, but all the embodiments. All other embodiments obtained by the ordinary skill in the art based on the embodiments in the disclosure without creative work are intended to be included in the scope of protection of the disclosure.

As shown in FIG. 1 to FIG. 3, the disclosure provides a folding pet cage, including two first frames 1 arranged opposite to each other, two second frames 2 arranged opposite to each other and a bottom net 3, wherein the first frame 1 is in rotatable connection with the adjacent second frame 2 through a hinge, the first frame 1 and the second frame 2 enclose an activity space for a pet; the second frame 2 includes at least two frame bodies 21, and any two adjacent frame bodies 21 are in rotatable connection through a hinge; in the present embodiment, two frame bodies 21 are provided, the two frame bodies 21 are in rotatable connection through a hinge, and the two frame bodies 21 are in rotatable connection with the first frame 1 on a corresponding side through a hinge respectively. The first frame 1 and/or the frame body 21 have/has one side near the activity space provided with a protrusion piece 13, the bottom net 3 can be placed above the protrusion piece 13 and the bottom net 3 has a peripheral side contacting the first frame 1 and the second frame 2, and feces excreted by a pet located above the bottom net 3 can pass through the bottom net 3 to fall below the bottom net 3. When the folding pet cage provided in the disclosure is not used, the second frame 2 is folded. When to mount and use the folding pet cage, it is only needed to pull the two first frames 1 arranged opposite to each other away from each other to unfold the second frames 2, then the bottom net 3 is placed on the protrusion piece 13 in the activity space to prop up the first frame 1 and the second frame 2. A pet can stand on the bottom net 3 and move in the activity space enclosed by the first frame 1 and the second frame 2. The folding pet cage is simple in structure, convenient to mount and suitable for widespread use.

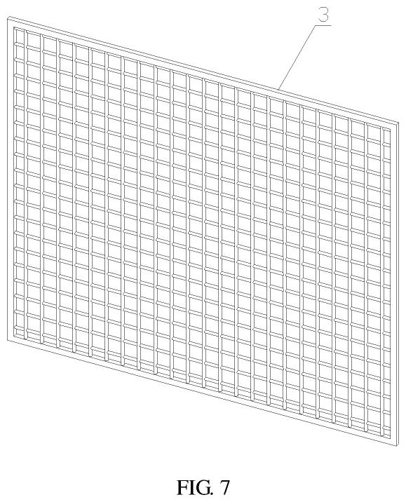

As shown in FIG. 1 to FIG. 7, pet feces can pass through the bottom net 3 to fall below the bottom net 3, preventing the feet of the pet being dipped in the feces, and keeping the pet clean and sanitary.

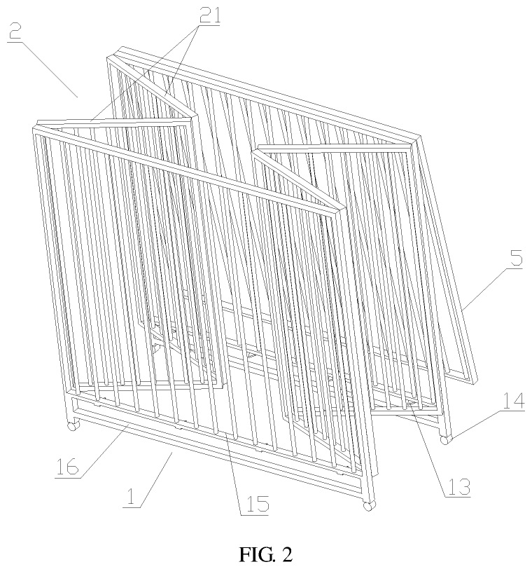

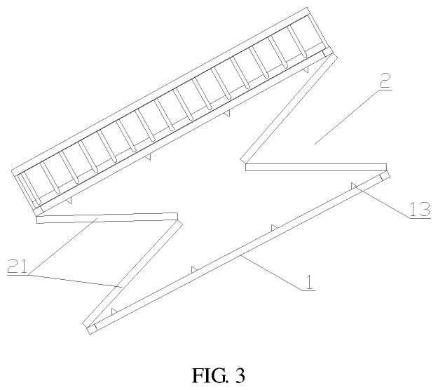

Specifically, as shown in FIG. 2 and FIG. 3, each first frame 1 includes a fence region 15, the protrusion piece 13 is located below the fence region 15, and the protrusion piece 13 is fixedly connected with the fence region 15. Further, for the bottom net 3 to be stably placed, at least two protrusion pieces 13 are arranged below each fence region 15.

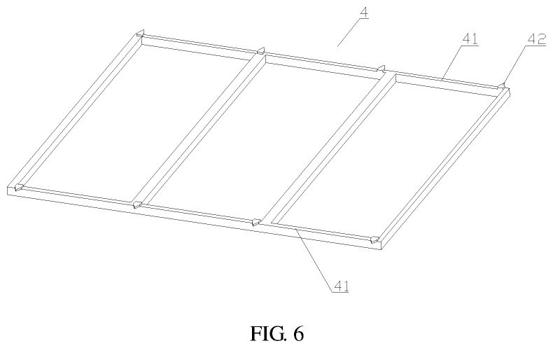

For convenient collection of animal feces, preferably, as shown in FIG. 1 to FIG. 2, each first frame 1 is further provided with a support rod 16, and the support rod 16 is located below the fence region 15 of the first frame 1. The pet cage further includes a bracket 4 (referring to FIG. 6), the bracket 4 has two sides arranged opposite to each other provided with an extension portion 42 respectively, and when the bracket 4 is mounted on the pet cage, the extension portion 42 on the bracket 4 can be put above the support rod 16 on a corresponding side. The pet cage further includes a tray, and when the tray is placed on the bracket 4, the tray and the bottom net 3 has a distance therebetween, and the pet feces falling from the bottom net 3 can fall onto the tray.

Preferably, referring to FIG. 1 and FIG. 6, the bracket 4 has a length less than a length of the support rod 16, a region on the bracket 4 provided with the extension portion 42 is a suspension region 41, the suspension region 41 is provided with at least two extension portions 42, and the suspension region 41 has two end portion regions along its length direction both provided with the extension portion 42. Referring to FIG. 1, when the bracket 4 is placed from the gap between the support rod 16 and the bottom net 3 and the extension portions 12 on two sides of the bracket 4 are put above corresponding support rods 16, the extension portions 42 on two end portion regions of the suspension region 41 are near the two ends of the support rod 16 along the length direction, thus reducing the amount of movement of the bracket 4 along the length direction of the support rod 16.

Further, for convenient transfer of the pet cage, preferably, a rotating wheel 14 is arranged below the first frame 1.

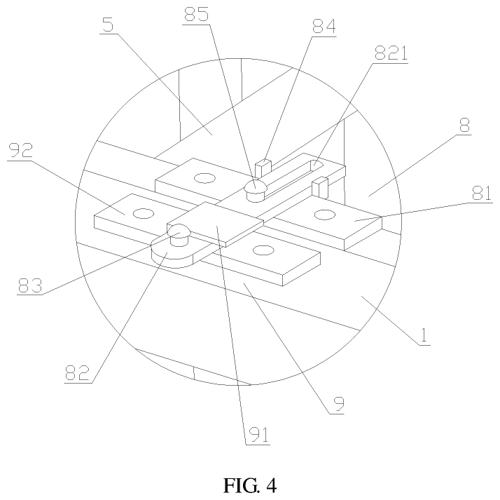

Preferably, referring to FIG. 1, the pet cage further includes an upper frame 5, the upper frame 5 has one end in rotatable connection with one of the two first frames 1, the upper frame 5 is capable of rotating around where the upper frame 5 is in rotatable connection with the first frame 1, and the upper frame 5 has the other end in detachable connection with the other one of the two first frames 1. Referring to FIG. 4, the detachable connection here includes a snap-fit portion 9 and a rotating portion 8, the snap-fit portion 9 is arranged on a top surface of the first frame 1 and the snap-fit portion 9 includes a fixed plate 92 and an L-shaped member 91, wherein the fixed plate 92 is connected with the first frame 1, the L-shaped member 91 is connected with the fixed plate 92. The rotating portion 8 includes a bottom plate 81 and a rotating member 82, wherein the bottom plate 81 is connected with a top surface of the upper frame 5, the rotating member 82 has one side provided with a guide groove 821, a screw 85 passes through the guide groove 821 to be connected with the bottom plate 81, and the screw 85 is capable of preventing the rotating member 82 disengaging along an axial direction of the screw 85, further, the rotating member 82 has the other side provided with a locating piece 83, the bottom plate 81 has one side far away from the snap-fit portion 9 provided with an anti-off pin 84, wherein there are two anti-off pins 84 provided, and the anti-off pins 84 are arranged on two sides of the screw 85 symmetrically, and a distance between the two anti-off pins 84 is slightly greater than a width of the rotating member 82.

When to detach and open the upper frame, referring to FIG. 4, pull the rotating member 82 along the direction in which the locating piece 83 gets far away from the screw 85, then the rotating member 82 can move in the direction far away from the screw 85 under the action of the guide groove 821 and the screw 85, and an end portion of the rotating member 82 can be pulled out from the two anti-off pins 84. Next, rotate the rotating member 82 counterclockwise. When the rotating member 82 is parallel to the bottom plate 81 of the rotating portion 8, push the rotating member 82 in the direction in which the locating piece 83 gets close to the screw 85, thereby finishing the action of opening.

When to use and fix the upper frame, pull the rotating member 82 along the direction in which the locating piece 83 gets far away from the screw 85, and then rotate the rotating member 82 clockwise; when the rotating member 82 enters the L-shaped member 91, push the rotating member 82 in the direction in which the locating piece 83 gets close to the screw 85, so that the rotating member 82 is inserted into the gap between the two anti-off pins 84 until the locating piece 83 contacts the L-shaped member 91, thereby finishing the action of fixing.

Further, to facilitate a pet to get in and get out the pet cage, referring to FIG. 1, the first frame 1 defines a pet exit, an openable and closable door 11 is arranged at the pet exit, the openable and closable door 11 has one end in rotatable connection with the first frame 1, and the openable and closable door 11 has the other end in detachable connection with the first frame 1. The openable and closable door 11 defines a feeding opening on a lower region thereof, a feeding door 12 is arranged at the feeding opening, the feeding door 12 has one end in rotatable connection with the openable and closable door 11, and the feeding door 12 has the other end in detachable connection with the openable and closable door 11.

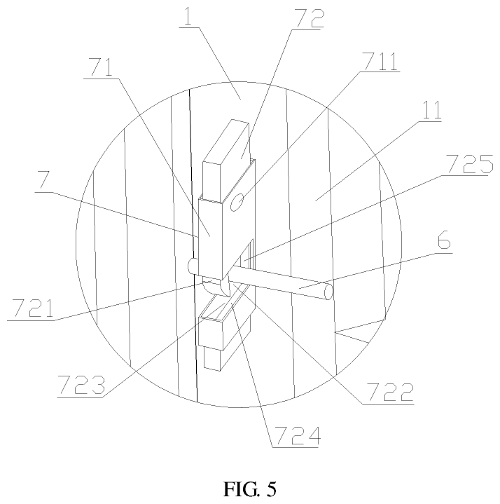

Specifically, referring to FIG. 5, the detachable connection here includes a locking portion 7 and a limit piece 6. Taking the detachable connection between the openable and closable door 11 and the first frame 1 for example, the limit piece 6 is rod shaped and the limit piece 6 is horizontally arranged on the openable and closable door 11. The locking portion 7 is arranged on the first frame 1, the locking portion 7 has a slide block 72 provided therein, the slide block 72 is capable of performing reciprocating rectilinear movement in the locking structure along a vertical direction, the slide block 72 defines a notch, a locking hook 721 is arranged at the notch, and when the limit piece 6 is pushed in a direction towards the locking portion 7, the limit piece 6 is capable of pushing the slide block 72 to move upwards and the limit piece 6 can enter a lockup region between the locking hook 721 and the slide block 72; further, the slide block 72 can return to an original state under the action of its gravity, and in this state the locking hook 721 of the slide block 72 is capable of preventing the limit piece 6 disengaging from the locking portion 7.

Specifically, the locking portion 7 includes a shell 71 and a slide block 72, wherein the shell 71 is connected with the first frame 1, further, the shell 71 defines a through hole vertically, the slide block 72 is arranged in the through hole, and the shell 71 further defines an opening. The slide block 72 defines a slide groove, the shell 71 defines a screw hole, a bolt 711 passes through the screw hole and the slide groove to be connected with the shell 71. Under the guide action of the bolt 711 and the slide groove, the slide block 72 is capable of moving up and down in the through hole of the shell 71 along the vertical direction. Meanwhile, the slide block 72 defines a notch, a locking hook 721 is arranged at one end of the notch far away from the first frame, the locking hook 721 and a side wall 724 of the notch define a translation space 723 therebetween, the locking hook 721 and a bottom wall 725 of the notch define a lockup space 722 therebetween. Moreover, one surface of the locking hook 721 near the first frame 1 is a flat surface, and one surface of the locking hook 721 far away from the first frame 1 is a curved surface. Particularly, in common state, the locking hook 721 is located in the notch of the shell 71 and the locking hook 721 is capable of preventing the limit piece 6 in the lockup space 722 disengaging. When holding the lower end of the slide block 72 (or catching the upper end of the slide block 72) to push (pull) the slide block 72 upwards, the locking hook 721 can be located above the opening of the shell 71, and the limit piece 6 is capable of moving across the translation space to move outside the locking portion 7.

Specifically, when the limit piece 6 is pushed in a direction towards the locking portion 7, the limit piece 6 first contacts the curved surface of the locking hook 721, moreover, the limit piece 6 is capable of pushing the locking hook 721 and the slide block 72 connected with the locking hook 721 to move from bottom to top, and the limit piece 6 enters the translation space 23. When the limit piece 6 continues to be pushed, the slide block 72 will move from top to bottom to its original position under the action of its gravity, then the limit piece 6 is located in the lockup space 722, and under the blocking action of the locking hook 721, the limit piece 6 cannot disengage from the locking portion.

When to take out the limit piece 6 from the locking portion 7, hold the lower end of the slide block 72 and move the slide block upwards, then pull the limit piece 6 to move outside the locking portion 7 from the translation space. Preferably, two groups of limit pieces 6 and locking portions 7 are arranged between the openable and closable door 11 and the first frame 1.

The above are the specific embodiments of the disclosure. However, the protection scope of the disclosure is not limited to the embodiments. Any variations or substitutions easily thought by one skill familiar with the technical field are intended to fall within the scope of protection of the disclosure. Therefore, the scope of protection of the disclosure should be based on the protection scope of the claims appended herein.

What is claimed is:

1. A folding pet cage, comprising two first frames (1) arranged opposite to each other, two second frames (2) arranged opposite to each other and a bottom net (3), wherein
the first frame (1) is in rotatable connection with the adjacent second frame (2), the first frame (1) and the second frame (2) enclose an activity space; the second frame (2) comprises at least two frame bodies (21), and any two adjacent frame bodies (21) are in rotatable connection; the first frame (1) and/or the frame body (21) have/has one side near the activity space provided with a protrusion piece (13), the bottom net (3) can be placed above the protrusion piece (13) and the bottom net (3) has a peripheral side contacting the first frame (1) and the second frame (2), and feces excreted by a pet located above the bottom net (3) can pass through the bottom net (3) to fall below the bottom net (3).

2. The folding pet cage according to claim 1, wherein the first frame (1) comprises a fence region (15), the protrusion piece (13) is located below the fence region (15), and the protrusion piece (13) is connected with the fence region (15).

3. The folding pet cage according to claim 2, wherein at least two protrusion pieces (13) are arranged below the fence region (15).

4. The folding pet cage according to claim 2, wherein the first frame (1) is further provided with a support rod (16), and the support rod (16) is located below the fence region (15); a bracket (4) has two sides arranged opposite to each other provided with an extension portion (42) respectively, and the extension portion (42) can be put above the support rod (16) on a corresponding side; the pet cage further comprises a tray, and when the tray is placed on the bracket (4), the tray and the bottom net (3) has a distance therebetween.

5. The folding pet cage according to claim 4, wherein the bracket (4) has a length less than a length of the support rod (16), a region on the bracket (4) provided with the extension portion (42) is a suspension region (41), the suspension region (41) is provided with at least two extension portions (42), and the suspension region (41) has two end portion regions along its length direction both provided with the extension portion (42).

6. The folding pet cage according to claim 1, wherein a rotating wheel is arranged below the first frame (1).

7. The folding pet cage according to claim 1, further comprising an upper frame (5), the upper frame (5) has one end in rotatable connection with one of the two first frames (1), the upper frame (5) is capable of rotating around where the upper frame (5) is in rotatable connection with the first frame (1), and the upper frame (5) has the other end in detachable connection with the other one of the two first frames (1).

8. The folding pet cage according to claim 1, wherein the first frame (1) defines a pet exit, an openable and closable door (11) is arranged at the pet exit, the openable and closable door (11) has one end in rotatable connection with the first frame (1), and the openable and closable door (11) has the other end in detachable connection with the first frame (1); the openable and closable door (11) defines a feeding opening, a feeding door (12) is arranged at the feeding opening, the feeding door (12) has one end in rotatable connection with the openable and closable door (11), and the feeding door (12) has the other end in detachable connection with the openable and closable door (11).

9. The folding pet cage according to claim 8, wherein the detachable connection comprises a locking portion (7) and a limit piece (6), the limit piece (6) is rod shaped and the limit piece (6) is horizontally arranged on the openable and closable door (11), the locking portion (7) is arranged on the first frame (1), the locking portion (7) has a slide block (72) provided therein, the slide block (72) is capable of performing reciprocating rectilinear movement in the locking structure along a vertical direction, the slide block (72) defines a notch, a locking hook (721) is arranged at the notch, when the limit piece (6) is pushed in a direction towards the locking portion (7), the limit piece (6) is capable of pushing the slide block (72) to move upwards and the limit piece (6) can enter a lockup region between the locking hook (721) and the slide block (72), and the locking hook (721) is capable of preventing the limit piece (6) disengaging from the locking portion (7).

10. The folding pet cage according to claim 8, wherein the feeding opening is near a lower region of the openable and closable door (11).
